(19) United States
(12) Patent Application Publication
(10) Pub. No.: US 2005/0207663 A1
(43) Pub. Date: Sep. 22, 2005

(54) Searching method and system for best matching motion vector

(76) Inventors: Weimin Zeng, San Jose, CA (US); Li Sha, San Jose, CA (US); Ping Zhu, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/064,738

(22) Filed: Feb. 23, 2005

Related U.S. Application Data
(63) Continuation-in-part of application No. 09/924,079, filed on Aug. 7, 2001.
(60) Provisional application No. 60/568,892, filed on May 7, 2004.
(60) Provisional application No. 60/309,239, filed on Jul. 31, 2001.

(51) Int. Cl. G06K 9/36; H04N 7/12

(52) U.S. Cl. 382/236; 375/240.17

(57) ABSTRACT

The invention relates generally to compression of video data and specifically to lowering at least a cost of motion information while encoding a macroblock. According to one embodiment, the present invention searches for a matching block that lowers a cost of encoding the macroblock including the cost of encoding motion information. According to another embodiment, the present invention lowers the cost of encoding the macroblock including the cost of encoding motion information at one or more stages of a multiresolution search.

### CROSS-REFERENCE TO RELATED APPLICATION

This application claims the benefit of U.S. Provisional Patent Application No. 60/568,892 filed on May 7, 2004, entitled “Video Processing System and Method,” which is incorporated by reference herein in its entirety. This application is a continuation-in-part of U.S. patent application Ser. No. 09/924,079, entitled “Cell Array And Method Of Multiresolution Motion Estimation And Compensation” filed on Aug. 7, 2001 which claims priority under 35 U.S.C. § 119(e) to co-pending U.S. Provisional Patent Application No. 60/309,239, entitled “Video Processing System with Flexible Video Format” filed Jul. 31, 2001, which are both incorporated by reference herein in their entirety.

### BACKGROUND OF THE INVENTION

1. Field of the Invention

The present invention relates generally to video image processing, and more particularly, to methods and techniques for motion estimation and compensation.

2. Background Art

Digital video is made up of many megabytes of pixel data per second of video. Storage, transmission, and processing of video data can be costly, consuming valuable resources such as memory, bandwidth, processing power, and time. Video data processing taxes even the fastest computer systems due to large image sizes and fast frame rates.

With the advent of digital television and streaming media, a number of new techniques have been developed over the recent past to allow video images to be processed and compressed. Moreover, a number of standards have been developed such as those developed by the Moving Pictures Experts Group (MPEG) for coding audio-visual information in a digital compressed format. Various new standards such as MPEG-4 or Advanced Video Coding (AVC) H.264 have been recently developed or are being developed and provide additional parameters to define the processing of digital video data. Additionally, there are a number of different transformation types that are being used to process and compress video data.

FIG. 1 illustrates a conventional approach 100 to coding audio-visual information into a digital compressed format. A raw video signal is input on line 110 to motion estimation and compensation unit 102 that generates the motion vectors and residual data, which determine how each motion compensated frame is predicted from a reference frame. Then a discrete cosine transform (DCT) unit 104 converts the spatial image pixel values into transform coefficients. The quantization unit 106 takes those coefficients and coarsely quantizes the less significant coefficients. The output of the quantization unit 106 is sent to a variable length coding (VLC) unit 108, which performs variable length coding to further compress the quantized image by representing higher frequency data with fewer bits than less frequently occurring data. The output of the VLC unit 108 is provided on line 114 and comprises the compressed image data.

Motion estimation and compensation techniques exploit spatial and temporal correlation between frames to compress image data. A frame may be divided into variable sized groups of pixels called blocks or macroblocks. In motion estimation and compensation, an assumption is made that an image in the current frame is a translation of an image in a previous frame. Therefore, a matching block in a previous frame may be used to predict a current macroblock in the current frame to be encoded. Using conventional means, the current macroblock may then be represented in reference to the matching block by means of motion information and texture information.

Motion information provides information about the motion of an object between frames, for example by means of a motion vector representing a spatial offset between the coordinates of the current macroblock in the current frame and the coordinates of its matching block in a previous frame. Texture information provides information about the pixels values of the current macroblock, for example by means of residual data storing the differences between corresponding pixels of the current macroblock and its matching block.

In general, motion estimation and compensation involves ascertaining which matching block from a reference frame should be used to predict the current macroblock, and using the resulting motion vector and residual data to represent the macroblock data in compressed form. Conventional techniques lower the cost of texture information such as residual data by selecting a matching block so as to minimize the differences between corresponding pixels of the current macroblock and the matching block. Specifically, the conventional way to select a matching block is to minimize the Sum of Absolute Differences (SAD) between corresponding pixels of the current macroblock and a matching block. Calculation of SAD may be represented by equation 1 below, where n is the number of pixels in the current macroblock and the matching block, matchᵢ is the i^{th} pixel of the matching block and curᵢ is the i^{th} pixel of the current macroblock.

$$SAD = {\sum }_{i = 1}^{n} \vert {match}_{i} - {cur}_{i} \vert \qquad ( 1 )$$

One problem with existing approaches is that they do not account for the cost of encoding motion information, such as a motion vector, in selecting a matching block for motion estimation and compensation. Encoding motion information represents a significant cost of encoding a macroblock, and motion information is conventionally encoded separately for each macroblock in a frame. The cost of motion information has become especially critical with the development of new standards such as MPEG-4. However, accounting for the cost of motion information is difficult to implement using conventional techniques.

Another problem with existing approaches is that they fail to account for quantization while selecting a matching block. As explained above, residual data generated during motion estimation and compensation is transformed into spatial frequency coefficients by means of a Discrete Cosine Transform. By coarsely quantizing the less significant coefficients, quantization lowers the number of bits required to represent residual data, thereby lowering the cost of residual data. The quantization scale determines how coarsely the coefficients are represented, with larger quantization values lowering encoding costs at the expense of resolution, while smaller quantization values providing better resolution at the expense of higher encoding costs. Accordingly, the quantization scale affects the cost of encoding residual data. However, existing approaches fail to factor in the quantization scale while evaluating the cost of texture information such as residual data in selecting a matching block.

Another problem with existing approaches is that traditional processors employed in motion estimation and compensation utilize a single instruction stream, multiple data stream (SIMD) architecture. SIMD architectures are suitable for simultaneously executing the same instruction over multiple processors. For example, SIMD architectures are suitable for calculating the cost of texture information such as SAD, which may be computed in parallel for several matching blocks. However, SIMD architectures are not suitable for calculating the cost of motion information.

Accordingly, there is a need for a system and method that accounts for the cost of motion information while selecting a matching block for motion estimation and compensation. More particularly, there is a need for encoding motion information with fewer bits during compression of video data. Further, when the cost of texture information is considered in selecting a matching block, there is a need to factor in a quantization scale that affects the cost of texture information. Moreover, during motion estimation and compensation, there is a need for utilizing an architecture that may simultaneously execute heterogeneous instructions for calculating the cost of motion information.

### SUMMARY OF THE INVENTION

The present invention provides a system and method for compression of video data. According to one embodiment, the present invention reduces the cost of encoding motion information for a current macroblock by selecting a matching block that lowers the cost of encoding motion information. For example, motion information for a current macroblock may be encoded as a differential motion vector, and a matching block is selected so as to lower the differential. The present invention advantageously encodes motion information with fewer bits to lower the cost of encoding motion information.

According to another embodiment, the present invention lowers the cost of encoding motion information as well as texture information while encoding a macroblock. To calculate the total cost of encoding the macroblock, one embodiment of the present invention advantageously includes a quantization scale to find the matching block.

The motion estimation and compensation unit of the present invention receives an input stream of video data and is preferably coupled to a discrete cosine transform unit. According to one embodiment, the motion estimation and compensation unit comprises a block selector, a memory, a search module and a cost calculator. The block selector receives an input stream of video data and selects blocks for compression. The memory stores reference frames used to encode the selected blocks. The search module is coupled to receive a current block selected for compression from the block selector and to receive a reference frame from the memory. The search module is coupled to the cost calculator to determine the cost of encoding the selected block in reference to one or more block in the reference frame. The search module searches blocks in the reference frame for a matching block that lowers the cost of encoding motion information for the current block. The search module of the motion estimation and compensation unit outputs the matching block, and the current block is then encoded in reference to the matching block by means of motion information and texture information.

The present invention includes a method of compressing video data. The method preferably comprises the steps of: receiving a block for compression and encoding the block in reference to a matching block that lowers at least a cost of motion information for the block.

### BRIEF DESCRIPTION OF THE DRAWINGS

The accompanying drawings illustrate several embodiments of the invention and, together with the description, serve to explain the principles of the invention.

FIG. 1 is a block diagram of a video processing system according to the prior art.

FIG. 2A is a block diagram of a first embodiment of a system for motion estimation and compensation according the present invention.

FIG. 2B is a block diagram of a second embodiment of a system for motion estimation and compensation according to the present invention.

FIG. 3 is a flowchart of a first embodiment of a method for motion estimation and compensation according to the present invention.

FIG. 4 is a flowchart of a second embodiment of a method for motion estimation and compensation according to the present invention.

FIG. 5 is a flowchart of a method of searching for a best matching motion vector according to one embodiment of the present invention.

FIG. 6A is an illustration of a search area within a reference frame according to one embodiment of the present invention.

FIG. 6B is an illustration of a current macroblock within a current frame according to one embodiment of the present invention.

FIG. 7A is an illustration of a preliminary motion vector and a preliminary matching block according to one embodiment of the present invention.

FIG. 7B is an illustration of a refined search area for performing full pixel level searching, and a resulting intermediate motion vector, according to one embodiment of the present invention.

FIG. 7C is an illustration of a further refined search area for performing fractional pixel level searching, and a resulting final motion vector, according to one embodiment of the present invention.

FIG. 8 is an illustration of a motion vector array according to one embodiment of the present invention.

FIG. 9 is an illustration of motion vector arrays for a current frame being encoded according to one embodiment of the present invention.

FIG. 10 is an illustration of a processing order for macroblocks in a current frame according to one embodiment of the present invention.

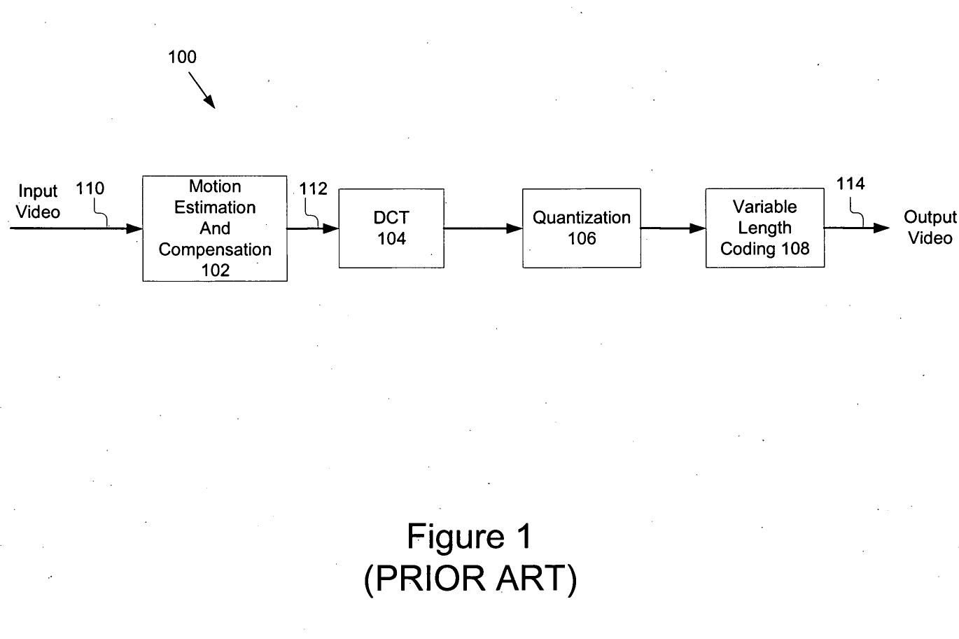

### DETAILED DESCRIPTION OF THE INVENTION

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In some instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

Motion estimation and compensation involves compression of each macroblock in a current frame in reference to a matching block from a reference frame. According to one embodiment, the reference frame may be a previous frame in the stream of video data. For each macroblock in the current frame, a reference frame is searched to determine the best matching block to be used for prediction. The present invention will now be described in terms of two ways of searching a reference frame for a matching block during motion estimation and compensation. According to one embodiment, the present invention is described in terms of a full search of a reference frame. According to a second embodiment, the present invention is described in terms of a multiresolution search of a reference frame. A multiresolution search preferably involves a partial pixel level search, a full pixel level search, and a fractional pixel level search. However, those skilled in the art will recognize that the present invention is applicable to various types of searches and various types of multiresolution searches involving a varying number of searches at varying levels of pixel resolution. Accordingly, the present invention is applicable to any method or system of searching a reference frame for a matching block. More generally, those skilled in the art will recognize that the present invention is applicable to any method or system of encoding video data.

In this application, the following terms are used:

“Pixel” refers to an individual picture element in an image that may be part of a video stream. An image is made up of many pixels organized into rows and columns. Each pixel independently represents a color and luminosity or brightness that may be different from all surrounding pixels in the image. Subsequent images in the video stream have pixels at the same location that are independent from the pixel in the current image.

“Frame” refers to a single image in a digital video stream. For example, many digital video streams have 30 frames per second or 30 individual images that make up one second of video.

“Resolution” refers to the number of pixels in the rows and columns of the image. For instance, it may be said that the resolution of a high-definition television (HDTV) frame is 1920×1080 pixels, meaning that there are 1920 columns of pixels and 1080 rows of pixels in a single frame of an HDTV video.

The terms “block,” “macroblock,” and “matching block” each refers to a group of one or more pixels.

The term “encoding” a block refers to representing the block with one or more bits or signal values. Encoding a block preferably reduces the number of bits or signal values required to represent the block.

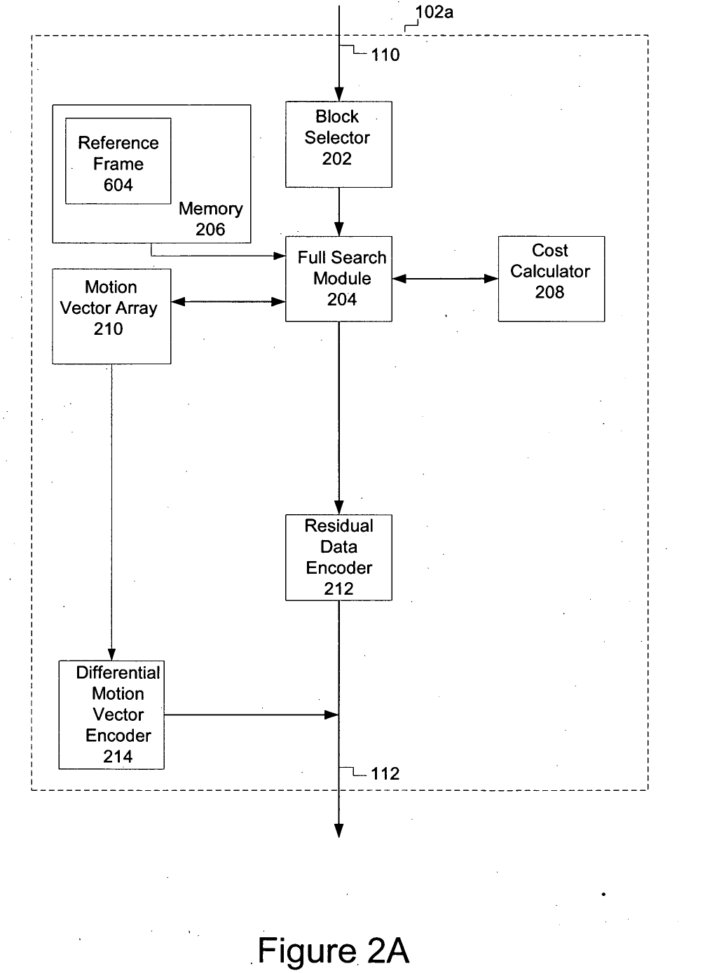

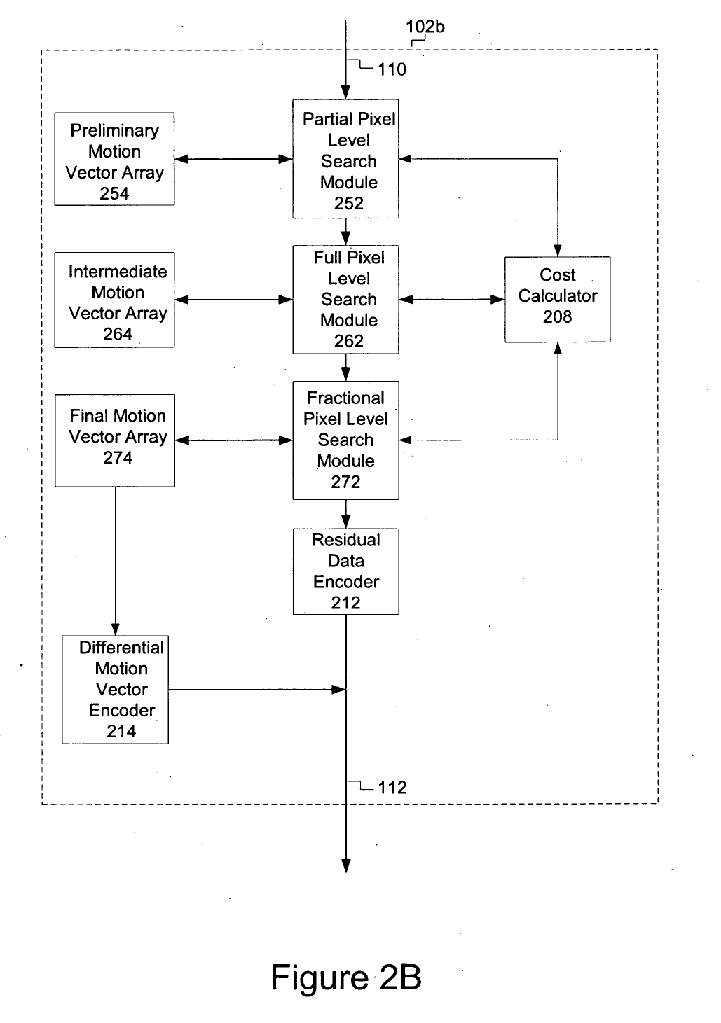

Referring now to FIG. 2A, one embodiment of the motion estimation and compensation unit 102a of the present invention is shown in more detail. The unit 102a represents hardware for motion estimation and compensation according to one embodiment of the present invention. A hardware embodiment of the invention has been described for ease of understanding. However, one skilled in the art will recognize that the modules, features, attributes, methodologies, and other aspects of the invention can be implemented as software, hardware, firmware or any combination of the three.

The unit 102a preferably comprises: a block selector 202, an full search module 204, a memory 206, a cost calculator 208, a motion vector array 210, a residual data encoder 212, and a differential motion vector encoder 214.

According to an exemplary embodiment, the present invention compresses video data on a macroblock-by-macroblock basis. The macroblocks are preferably groups of 16×16 pixels. The block selector 202 has an input and an output and is used to selects macroblocks for compression. The input of block selector 202 is coupled to receive an input video signal 110, and the output of block selector 202 is coupled to the input of a full search module 204. The block selector 202 provides a macroblock to full search module 204 for compression.

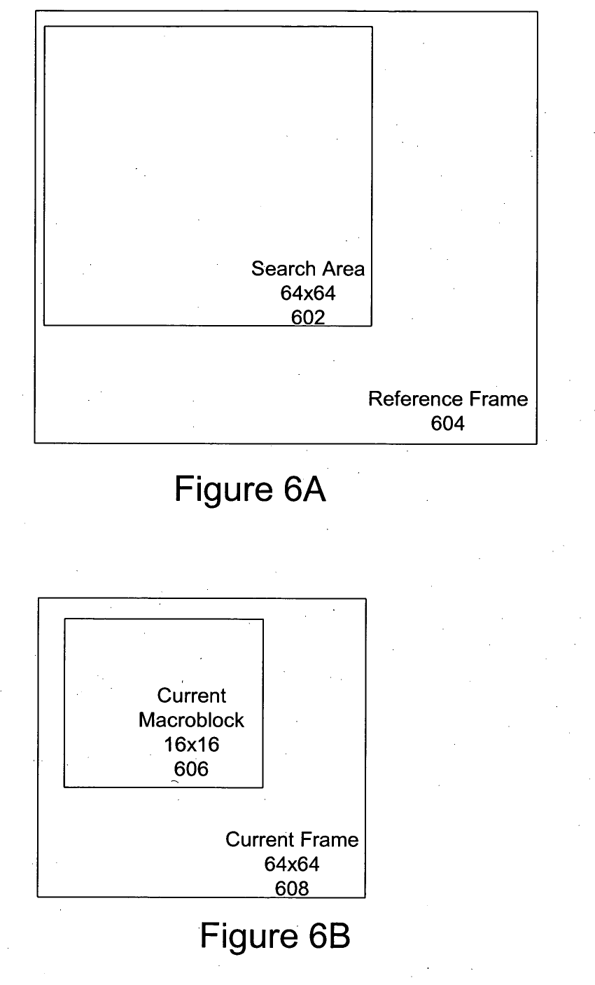

FIG. 6B provides an illustration of a current macroblock 606 within a current frame 608 that is selected for compression. The current frame 608 is assumed to be of size 64×64 pixels for illustrative purposes, but those skilled in the art will recognize that the present invention is applicable to frames or macroblocks of different sizes. In the present example, block selector 202 provides current macroblock 606 to full search module 204 for compression.

FIG. 6A provides an illustrative example of a search area 602 within a reference frame 604. Search area 602 is assumed to be of size 64×64 pixels for illustrative purposes, but those skilled in the art will recognize that the present invention is applicable to search areas or reference frames of different sizes. Further, the size of search area 602 may be different from the size of current frame 608.

The memory 206 is preferably one or more data storage locations, registers or memory locations accessible by full search module 204 to retrieve the reference frame 604 that is used by the full search module 204 to locate a matching block. These data storage locations can be accessed by other hardware and software devices (not shown) to load the reference frame 604 to memory 206.

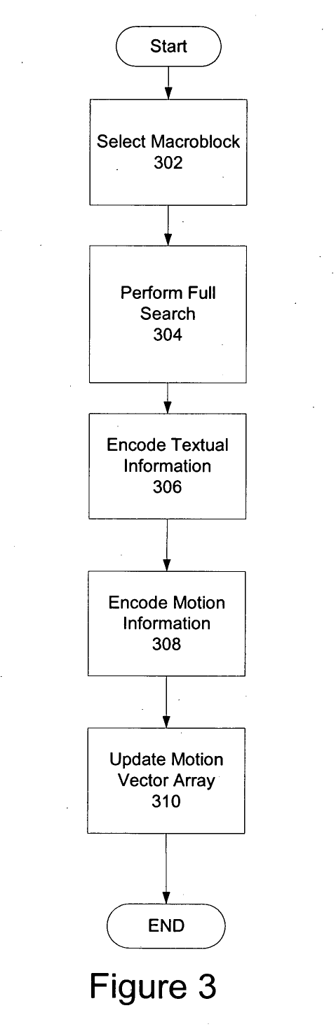

The full search module 204 searches for the best matching block in the search area 602. The input of full search module 204 is coupled to block selector 202, memory 206, cost calculator 208, and motion vector array 210. The output of full search module 204 is coupled to cost calculator 208, motion vector array 210, and residual data encoder 212. According to one embodiment, full search module 204 receives current block 606 from block selector 202, and receives reference frame 604 from memory 206. Full search module 204 exhaustively searches each matching block in search area 602 to find the best matching block for current macroblock 606. Preferably, the best matching block is the one that allows current macroblock 606 to be encoded at least cost. The present invention advantageously includes the cost of motion information in finding the best matching block. The full search performed by the present invention will be described in more detail below with reference to FIG. 3.

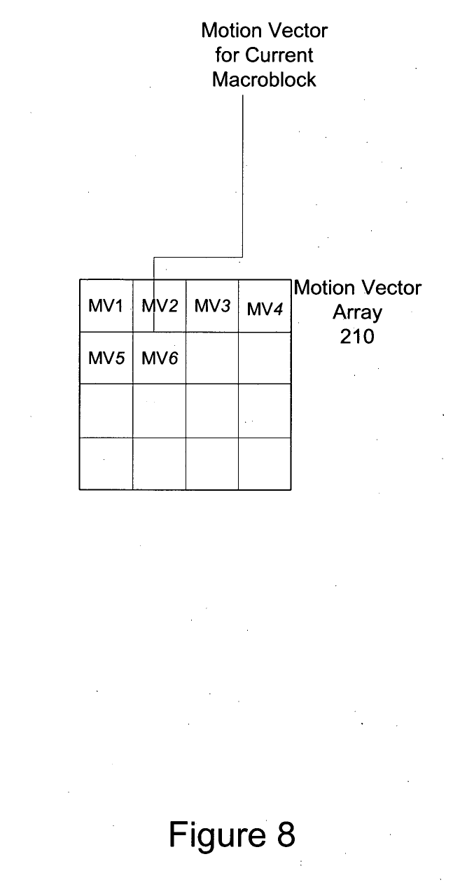

The present invention preferably uses motion vector array 210 to store the best matching motion vector for each macroblock in current frame 608. According to one embodiment of the present invention, motion information for the current macroblock 606 is encoded using a differential motion vector that represents the difference between the motion vector of current macroblock 606 and the median motion vector of one or more other macroblocks, thereby allowing compression of motion information 606 and lowering the cost of encoding motion information. Calculation of a differential motion vector is described in more detail below. Motion vector array 210 enables calculation of a differential motion vector for the current macroblock 606. FIG. 8 provides an illustrative example of motion vector array 210. According to the example shown in FIG. 8, the current frame 608 of size 64×64 pixels, is composed of 16 macroblocks, each of size 16×16 pixels. As seen in FIG. 8, current macroblock 606 is the sixth macroblock in current frame 608. Motion vector array 210 has an input and two outputs.

Referring back to FIG. 2A, motion vector array 210 has an input and two outputs. One output of motion vector array 210 is coupled to full search module 204 to provide information regarding the best matching motion vectors for previous macroblocks in current frame 608. One input of motion vector array 210 is coupled to full search module 204 to receive the best matching motion vector for current macroblock 606, while the second output of motion vector array 210 is coupled to differential motion vector encoder 214 to enable calculation of the differential motion vector for current macroblock 606.

Cost calculator 208 has an input and an output and is used to calculate the cost of encoding current macroblock 606 in reference to a particular matching block from search area 602. Cost calculator 208 of the present invention advantageously includes the cost of encoding motion information into the total cost of encoding current macroblock 606. According to an exemplary embodiment, motion information for current macroblock 606 is encoded as a differential motion vector, and cost calculator 208 calculates the total cost of encoding current macroblock 606 and includes in that calculation the cost of encoding the differential motion vector. The input of cost calculator 208 is coupled to full search module 204 to receive current macroblock 606 and a particular matching block from search area 602. The output of the cost calculator 208 is coupled to full search module 204 to provide the cost of encoding the current macroblock 606 in reference to the particular matching block.

Residual data encoder 212 has an input and an output and is used to encode texture information for current macroblock 606 in the form of residual data. The input of the residual data encoder 212 is coupled to the output of the full search module 204 for receiving current macroblock 606 and its best matching block. The output of the residual data encoder 212 is provided on line 112 and is coupled to the input of the DCT unit 104 to provide compressed texture information for current macroblock 606.

The differential motion vector encoder 214 has an input and an output and is used to calculate the differential motion vector for current macroblock 606 as described in more detail below. The input of the differential motion vector encoder 214 is coupled to the output of the motion vector array 210, while the output of differential motion vector encoder 214 is coupled to DCT unit 104 to provide compressed motion information for current macroblock 606.

An exemplary embodiment of the present invention lowers the cost of encoding motion information by using the concepts of a predictor motion vector and a differential motion vector while encoding a macroblock. As explained above, a motion vector provides information about the movement of an object between frames by specifying a spatial offset between the coordinates of current macroblock 606 in current frame 608 and the coordinates of its matching block in a previous frame. A macroblock is a group of pixels that represent an image, and a motion vector for the macroblock specifies the movement of the image between a previous frame (for example, reference frame 604) and current frame 608. The present invention uses the insight that neighboring (adjacent) pixels are likely to move along similar paths between reference frame 604 and current frame 608. For example, if a solid object, such as a ball, is following a certain trajectory between reference frame 604 and current frame 608, each pixel of the ball is likely to follow a similar trajectory. Therefore, neighboring macroblocks in current frame 608 are likely to have similar motion vectors. This similarity between the motion vectors of neighboring macroblocks can be exploited by encoding motion information for current macroblock 606 as a differential motion vector between current macroblock 606 and its neighbors. For example, motion information for current macroblock 606 may be encoded as a differential motion vector as shown in equation 2 below.
Differential Motion Vector for Current Macroblock=Motion Vector Information for Neighboring Macroblocks−Motion Vector for Current Macroblock (2)

Since the motion vector for a current macroblock is likely to be similar to the motion vectors for its neighboring macroblocks, the differential motion vector is likely to have small values, thereby allowing motion information to be encoded using fewer number of bits. Motion vector information for neighboring macroblocks is referred to as a predictor motion vector. Therefore, the equation 2 may be re-written as equation 3 below.
Differential Motion Vector for Current Macroblock=Predictor Motion Vector for Current Macroblock−Motion Vector for Current Macroblock (3)

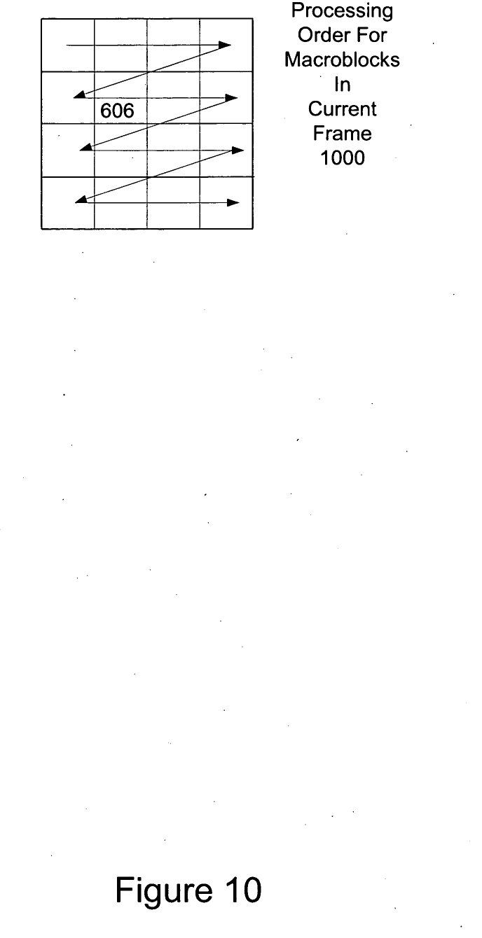

According to one embodiment, a predictor motion vector represents the median motion vector of previously encoded neighboring macroblocks in current frame 608. FIG. 10 shows an exemplary processing order for macroblocks in current frame 608. Referring to FIG. 8, motion vectors for each macroblock of current frame 608 are stored in a motion vector array 210. According to the processing order in FIG. 10, motion vectors MV1 through MV5 are known during calculation of the MV6, the motion vector for the current macroblock 606. In an exemplary embodiment, the predictor motion vector for current macroblock 606 represents the median of three previously calculated, neighboring motion vectors: MV2, MV3, and MV5.

According to one embodiment, while selecting a matching block to encode current macroblock 606, the present invention attempts to lower the cost of encoding motion information. For example, motion information is encoded as a differential motion vector and the best matching block is chosen so as to lower the differential motion vector for current macroblock 606. While encoding current macroblock 606 in reference to a matching block in reference frame 604, the best matching block is chosen so as to lower the differential between the resulting motion vector MV6 for current macroblock 606 and its neighboring motion vectors MV2, MV3, and MV5.

Referring now to FIG. 2B, a second embodiment of the motion estimation and compensation unit 102b of the present invention is shown in more detail. According to the second embodiment, unit 102b represents hardware for motion estimation and compensation. The second embodiment has been described as a hardware embodiment for ease of understanding. However, one skilled in the art will recognize that the modules, features, attributes, methodologies, and other aspects of the invention can be implemented as software, hardware, firmware or any combination of the three. According to the second embodiment, the present invention is described in terms of a multiresolution search of reference frame 604. Preferably, a multiresolution search involves a partial pixel level search, a full pixel level search, and a fractional pixel level search.

The second embodiment of motion estimation & compensation unit 102b preferably comprises: a partial pixel level search module 252, a full pixel level search module 262, a fractional pixel level search module 272, a preliminary motion vector array 254, an intermediate motion vector array 264, a final motion vector array 274, a cost calculator 208, a residual data encoder 212, and a differential motion vector encoder 214. Memory 206 has not been shown in this embodiment for convenience and ease of understanding although it may be coupled to one or more of partial pixel level search module 252, full pixel level search module 262, and fractional pixel level search module 272.

A method and system for multiresolution motion estimation and compensation has been described in detail in U.S. patent application Ser. No. 09/924,079, which has been incorporated by reference herein in its entirety. Multiresolution motion estimation and compensation reduces the cost of searching a reference frame for a matching block. A multiresolution search reduces the number of comparisons required to find the best matching block by performing a varying number of searches at different levels of pixel resolution. FIG. 2B describes one embodiment of the present invention in which the present invention is applied to multiresolution motion estimation and compensation.

According to an exemplary embodiment, unit 102b performs a three stage multiresolution search. In the first stage, unit 102b performs a low resolution search of search area 602 for a preliminary matching block and its associated preliminary motion vector. The preliminary motion vector provides an estimate of the best matching motion vector and limits the portion of the search area 602 that needs to be searched for the best matching motion vector. In the second stage, a full pixel level search is performed in the vicinity of the preliminary motion vector to determine an intermediate matching block and its associated intermediate motion vector. The intermediate motion vector provides a refined, pixel-level estimate of the best matching motion vector, and further limits the portion of search area 602 where the best matching motion vector is to be found. In the third stage, a partial pixel level search is performed in the vicinity of the intermediate motion vector to determine the best matching block and its associated best matching motion vector. The best matching motion vector may also be called the final motion vector for current macroblock 606. Although unit 102b describes a three stage multiresolution search, those skilled in the art will recognize that the present invention is readily scalable to perform a multiresolution search involving two or more stages of searching.

According to an exemplary embodiment of the present invention, the concepts of a predictor motion vector and a differential motion vector are employed at one or more stages of a multiresolution search. One embodiment of the invention attempts to lower the cost of encoding motion information at each stage of a multiresolution search. Specifically, at each stage of a multiresolution search, matching blocks are selected so as to lower the cost of encoding motion information by achieving a smaller differential motion vector for current macroblock 606.

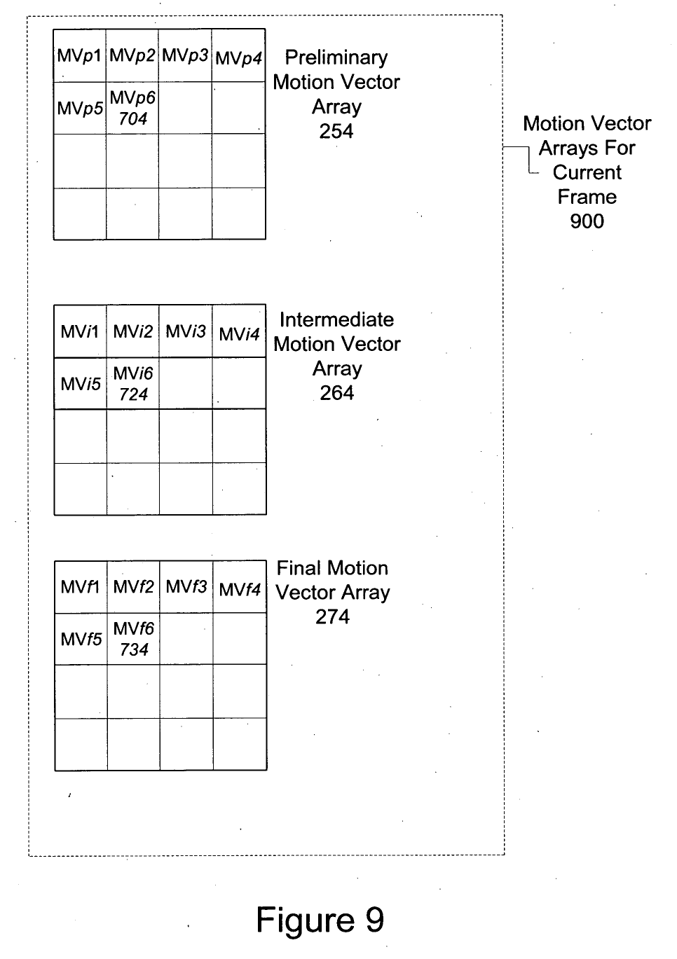

In an exemplary embodiment, during a partial pixel level search, the preliminary motion vector for current macroblock 606 is chosen so as to achieve a small preliminary differential with the preliminary predictor motion vector, from which represents preliminary motion vector information for neighboring macroblocks. According to an exemplary embodiment shown in FIG. 9, preliminary motion vector information for neighboring macroblocks is stored in a preliminary motion vector array 254, where it can be accessed for computation of the preliminary differential motion vector. The chosen preliminary motion vector for a macroblock determines the range of the final motion vector. By achieving a smaller preliminary differential motion vector, the present invention achieves a smaller final differential motion vector during multiresolution motion estimation and compensation for current macroblock 606, thereby lowering the cost of encoding motion information for current macroblock 606.

Similarly, during a full pixel level search, the intermediate motion vector for a current macroblock is chosen so as to achieve a small intermediate differential with the intermediate predictor motion vector, which represents intermediate motion vector information for neighboring macroblocks. According to an exemplary embodiment shown in FIG. 9, intermediate motion vector information for neighboring macroblocks is stored in an intermediate motion vector array 264, from where it can be accessed for computation of the intermediate differential motion vector. The chosen intermediate motion vector for a macroblock determines the range of the final motion vector. By achieving a smaller intermediate differential motion vector, the present invention achieves a smaller final differential motion vector during multiresolution motion estimation and compensation for current macroblock 606, thereby lowering the cost of encoding motion information for current macroblock 606.

Similarly, during a fractional pixel level search, the final motion vector for current macroblock 606 is chosen so as to achieve a small final differential with the final predictor motion vector, which represents final motion vector information for neighboring macroblocks. According to an exemplary embodiment shown in FIG. 9, final motion vector information for neighboring macroblocks is stored in a final motion vector array 274, from where it can be accessed for computation of the final differential motion vector. By achieving a smaller final differential motion vector, the present invention lowers the cost of encoding motion information for current macroblock 606 during multiresolution motion estimation and compensation.

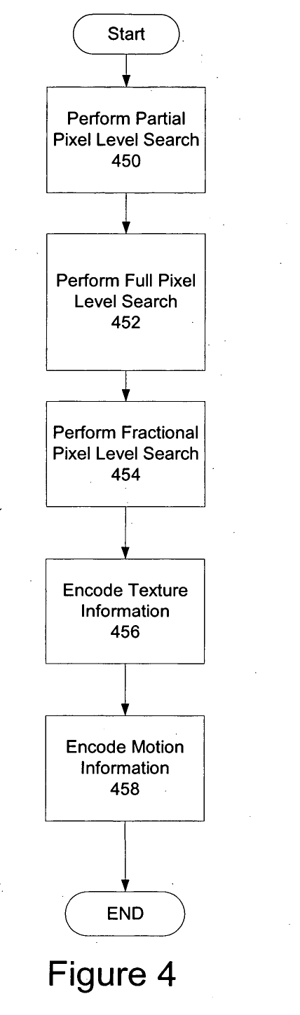

An embodiment of the present invention with reference to multiresolution motion estimation and compensation is described in more detail below with reference to FIG. 4. Referring again to FIG. 2B, according to an exemplary embodiment, partial pixel level search module 252 is coupled to input line 110 to receive video data. For example, partial pixel level search module 252 receives current macroblock 606 on input line 110, and receives reference frame 604 from memory (not shown). Partial pixel level search module 252 is also coupled to preliminary motion vector array 254, cost calculator 208 and full pixel level search module 262.

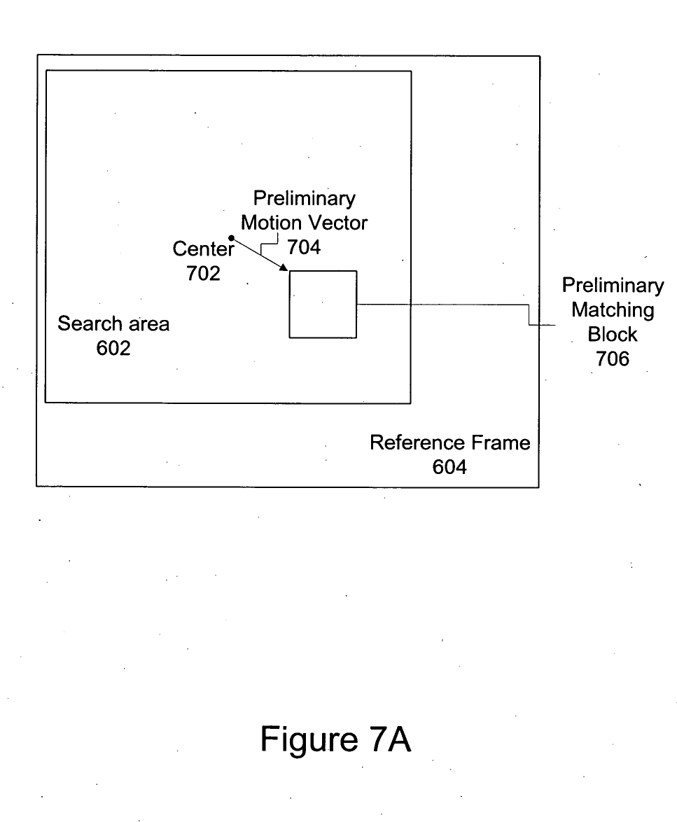

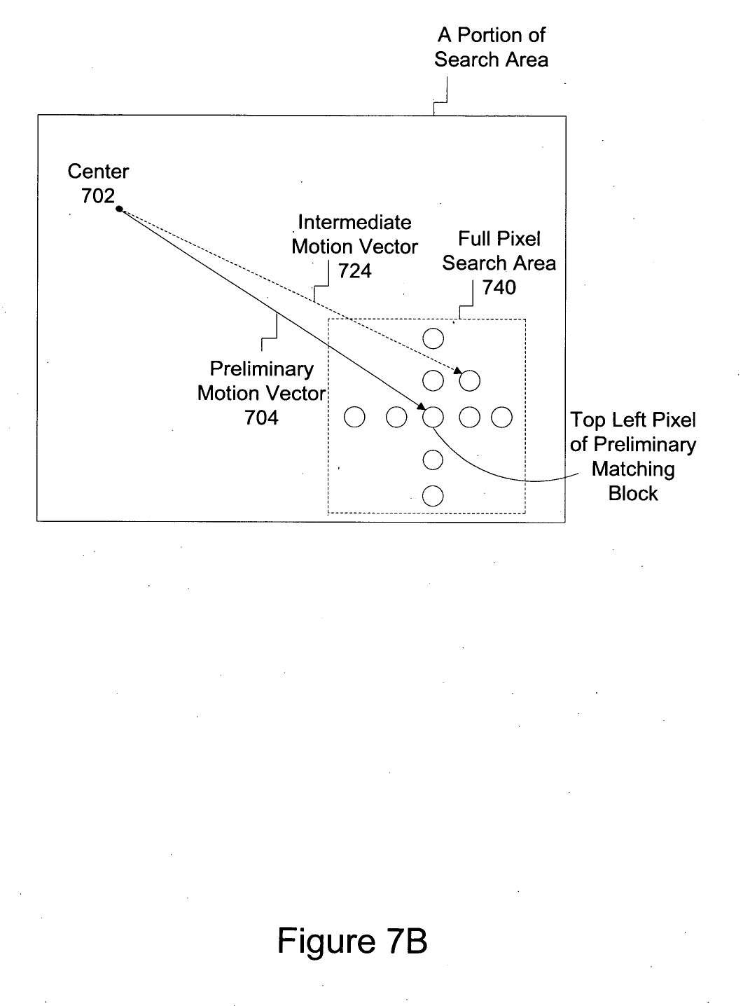

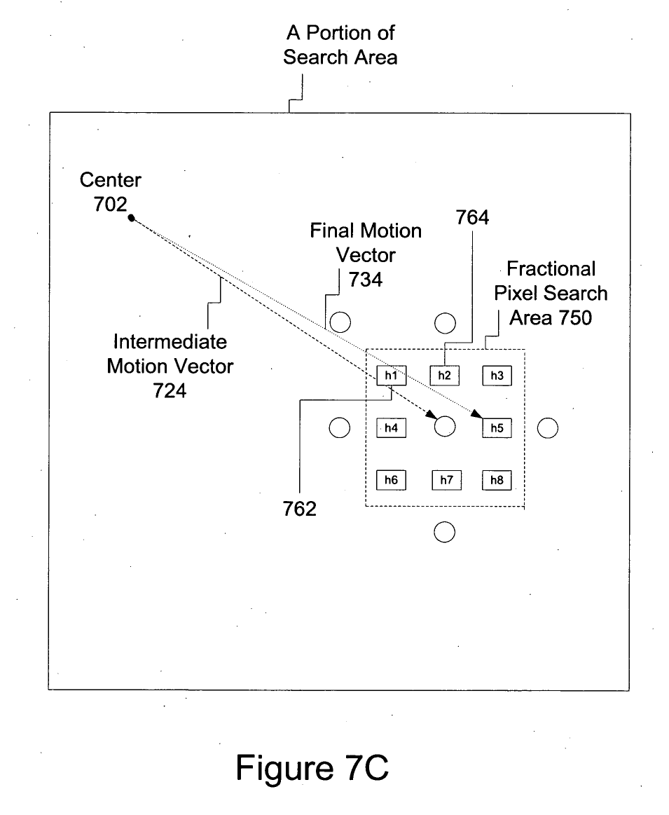

Partial pixel level search module 252 sub-samples search area 602, and performs a low resolution search of the sub-sampled blocks in search area 602. Partial pixel level search module 252 uses cost calculator 208 to determine the cost of encoding current macroblock 606 in reference to each sub-sampled block in search area 602. Preferably, the sub-sampled block that minimizes the cost of encoding current macroblock 606 is chosen to be the preliminary matching block 706 (FIG. 7A). As shown in FIG. 9, preliminary motion vector 704 (MVp6) with the preliminary matching block is stored in preliminary motion vector array 254. Preliminary motion vector 704 provides an estimate of the best matching motion vector and limits the portion of search area 602 that needs to be searched for the best matching motion vector. The partial pixel level search performed by the present invention will be described in more detail below with reference to FIG. 4.

Full pixel level search module 262 is coupled to partial pixel level search module 252 to receive current macroblock 606 and its preliminary motion vector 704. In an exemplary embodiment, reference frame 604 is received from memory (not shown). Full pixel level search module 262 is also coupled to intermediate motion vector array 264, cost calculator 208 and fractional pixel level search module 272.

Full pixel level search module 262 performs a pixel level search of the limited portion of search area 602 defined by preliminary motion vector 704. Full pixel level search module 262 uses cost calculator 208 to determine the cost of encoding current macroblock 606 in reference to each block in the limited portion of search area 602 defined by preliminary motion vector 704. Preferably, the block that minimizes the cost of encoding current macroblock 606 is chosen to be the intermediate matching block.

As shown in FIG. 9, an intermediate motion vector Mvi6 724 (FIG. 7B) associated with the intermediate matching block is stored in intermediate motion vector array 264. Intermediate motion vector 724 provides a refined, pixel-level estimate of the best matching motion vector and defines a further limited portion of search area 602 where the best matching motion vector is to be found. The full pixel level search performed by the present invention will be described in more detail below with reference to FIG. 4.

Fractional pixel level search module 272 is coupled to full pixel level search module 262 to receive current macroblock 606 and its intermediate motion vector 724. In an exemplary embodiment, reference frame 604 is received from memory (not shown). Fractional pixel level search module 272 is also coupled to final motion vector array 274, cost calculator 208 and residual data encoder 212.

Fractional pixel level search module 272 performs a fractional pixel level search of the further limited portion of search area 602 defined by intermediate motion vector 724. According to an exemplary embodiment as illustrated in FIG. 7C, fractional pixel level search module 272 searches fractional pixel blocks in the vicinity of intermediate motion vector 724, and uses cost calculator 208 to determine the cost of encoding current macroblock 606 in reference to each fractional pixel block. Preferably, the block that minimizes the cost of encoding current macroblock 606 is chosen to be the best matching block.

As shown in FIGS. 7C and 9, final motion vector MVf6 734 associated with the best matching block is stored in final motion vector array 274. Current macroblock 606 is encoded in reference to the best matching block, which advantageously allows compression of motion information. The fractional pixel level search performed by the present invention will be described in more detail below with reference to FIG. 4.

Residual data encoder 212 has an input and an output and is used to encode texture information for the current macroblock 606 in the form of residual data. The input of the residual data encoder 212 is coupled to the output of fractional pixel level search module 272 for receiving current macroblock 606 and its best matching block. The output of the residual data encoder 212 is coupled to the input of DCT unit 104 to provide compressed texture information for current macroblock 606 to DCT unit 104.

Differential motion vector encoder 214 has an input and an output and is used to calculate the final differential motion vector for current macroblock 606 during multiresolution motion estimation and compensation. The input of the differential motion vector encoder 214 is coupled to the output of final motion vector array 274, while the output of differential motion vector encoder 214 is coupled to DCT unit 104 to provide compressed motion information for the current macroblock 606 to DCT unit 104.

Various embodiments of a method of motion estimation and compensation are described below. For each macroblock from current frame 608 being encoded, motion estimation and compensation involves searching for a best matching block in reference to which each macroblock is to be encoded. Referring to FIGS. 6A through 10, the discussion below provides an illustration of motion estimation and compensation for current macroblock 606 in current frame 608 being encoded. In the discussion below, motion estimation and compensation involves searching a search area 602 of a reference frame 604 for the best matching block to be used in encoding current macroblock 606. The present invention advantageously lowers the cost of compressing motion information during motion estimation and compensation.

Referring now to FIG. 3, a first embodiment of a method for motion estimation and compensation according to the present invention will be described. The method begins in step 302 by selecting current macroblock 606 for compression from a stream of video data. According to an embodiment illustrated in FIG. 6B, current frame 608 of size 64×64 pixels is received in a stream of video data and is divided into 16 macroblocks, each of size 16×16 pixels, of which current macroblock 606 is selected for compression. Those skilled in art will recognize that the present invention may be applied to frames of various sizes that are divided into macroblocks of various sizes.

At step 304, the method performs a full search of search area 602 within reference frame 604 to find the best matching block for current macroblock 606 and its associated best matching motion vector. During a full search, each block in search area 602 is searched to determine the best matching block that lowers the cost of encoding current macroblock 606. This process can be analogized to having current macroblock 606 overlaid at an initial position within search area 602. The cost of encoding current macroblock 606 with reference to the overlaid block in search area 602 is determined. An exhaustive search is then performed wherein current macroblock 606 is moved one pixel vertically or horizontally within search area 602, and the cost of encoding current macroblock 606 in reference to each overlaid block is determined. This process continues until the cost of encoding current macroblock 606 in reference to each block in search area 602 has been determined. The block resulting in the lowest encoding cost is selected as the best matching block and current macroblock 606 is encoded in reference to the best matching block.

According to an exemplary embodiment, the total cost of encoding current macroblock 606 includes cost of texture information as well as cost of motion information. One way of calculating cost of texture information is by a correlation error between the pixel intensity values of current macroblock 606 and the overlaid search area. Exemplary techniques for determining the correlation error include mean absolute error and mean square error. According to one embodiment, cost of encoding motion information represents the cost of encoding the best matching motion vector, which may be advantageously encoded as a differential motion vector as explained above.

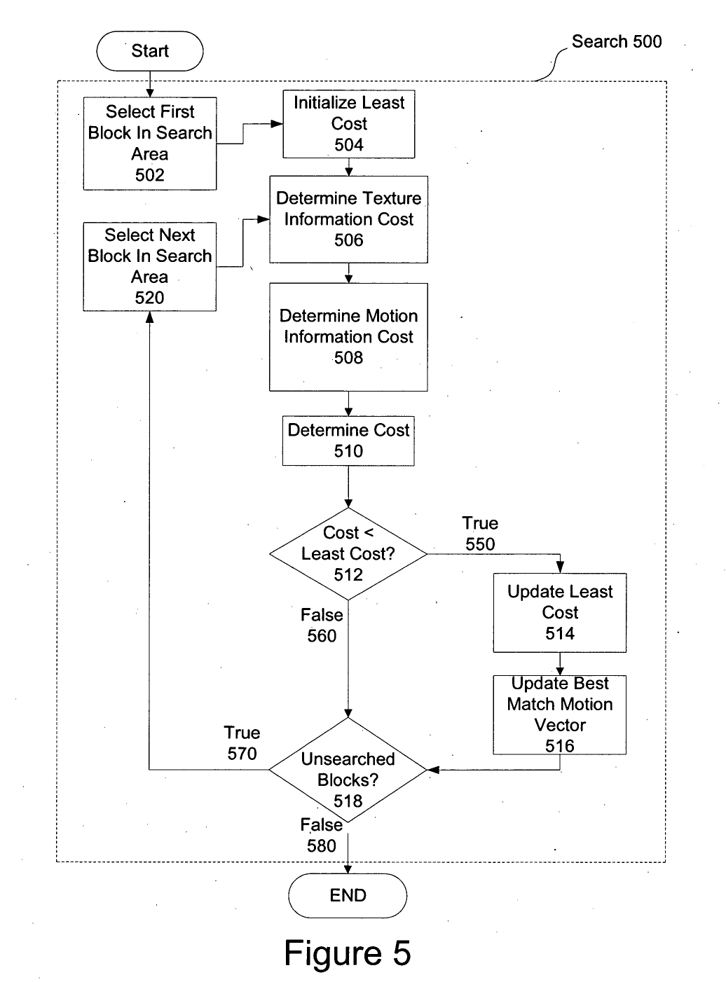

Step 304 is now explained in further detail with reference to an exemplary search 500 illustrated in FIG. 5. At step 502 of full search 304, the method selects a first block in search area 602 having the same dimensions as current macroblock 606. According to an exemplary embodiment in which current macroblock 606 contains 16×16 pixels, the method selects the upper-left block of size 16×16 in search area 602. Then, at step 504, the method initializes the least cost for encoding current macroblock 606 to the highest possible cost for encoding a macroblock. The least cost is stored in memory 206.

Once a block from search area 602 has been selected, at step 506 the method calculates the cost of encoding texture information for encoding current macroblock 606 in reference to the selected block. A conventional way to calculate the cost of texture information is to calculate the Sum of Absolute Differences (SAD) between corresponding pixels of current macroblock 606 and the selected block, as shown in equation 4 below. In equation 4, refᵢ refers to the i^{th} pixel of the selected block from search area 602, curᵢ refers to the i^{th} pixel of current macroblock 606, and n is the number of pixels in current macroblock 606 and in the selected block.

$$SAD = {\sum }_{i = 1}^{n} \vert {ref}_{i} - {cur}_{i} \vert \qquad ( 4 )$$

Next, at step 508, the method determines the cost of encoding motion information for current macroblock 606 in reference to the selected block. According to an exemplary embodiment, motion information for current macroblock 606 is encoded as a differential motion vector, and the cost of encoding motion information is determined using a scaled motion vector differential as shown in equation 5 below. In equation 5, mvx and mvy represent the x and y coordinates of the resulting motion vector if current macroblock 606 is encoded in reference to the select block, while mvx_predict and mvy_predict represent the x and y coordinates of the predictor motion vector for current macroblock 606. According to an exemplary embodiment, the variable λ is a function of the quantization scale chosen to compress the residual data.
Scaled Motion Vector Differential=λ(|mvx−predict_{—}mvx|+|mvy−predict_{—}mvy |) (5)

At step 510, the method determines the total cost of encoding current macroblock 606 in reference to the selected block in search area 602. According to an exemplary embodiment, the total cost is a function of one or more cost components, such as a first cost and a second cost. Further, one or more of the cost components may be scaled by one or more variable or constant values to adjust the relative weights of the cost components. According to an exemplary embodiment of the total cost function, the first cost represents texture information cost and the second cost represents motion information cost. Specifically, the total cost may be determined by adding the SAD and Scaled Motion Vector Differential in equations 4 and 5 above, as shown in equation 6 below.
Total Cost=SAD+λ(|mvx−predict_{—}mvx|+|mvy−predict_{—}mvy|) (6)

According to one embodiment, quantization scale λ is included in the determination of total cost. In equation 6 above, one skilled in the art will recognize that the variable λ accounts for the relative importance of motion information cost versus texture information cost. A high quantization scale λ implies that residual data is coarsely quantized, meaning that the cost of texture information (SAD) should be relatively less significant than the cost of motion information, which is achieved by multiplying the cost of motion information by the higher lambda. Similarly, a low quantization scale λ results in higher resolution at a higher cost of texture information, meaning that the cost of motion information should be relatively less significant that the cost of texture information, which is achieved by multiplying the cost of motion information by the lower λ.

At step 512, the method determines whether the total cost determined at step 510 above is less than the least cost stored in memory 206 for encoding current macroblock 606. If this is true 505, then encoding current macroblock 606 in reference to the selected block results in the least cost determined so far for encoding current macroblock 606, and the selected block is the best matching block determined so far. Accordingly, the method updates the least cost 514 stored in memory 206 by setting it to be equal to the total cost, and updates the best matching motion vector 516, which is also stored in memory 206, to be the motion vector corresponding to the selected block. Next, the method continues at step 518 by checking whether there are unsearched blocks in search area 602.

If the comparison at step 512 is false 560, then the method continues directly to step 518 by checking whether there are unsearched blocks in search area 602.

At step 518, if it is true 570 that there are unsearched blocks in search area 602, the method selects next block in search area 602 at step 520, and then continues by re-performing steps 506 through 518 as described above. In an exemplary embodiment, the next block is determined by moving one pixel horizontally or vertically from the position of the selected block. At step 518, if it is determined that each block in search area 602 has been searched, then the best matching motion vector for current macroblock 606 has been determined and the full search ends.

Referring again to FIG. 3, at the end of step 304, the method has determined the best matching block and the best matching motion vector for current macroblock 606. The method continues at step 306 by encoding texture information for current macroblock 606, such as residual data representing the differences between corresponding pixels of current macroblock 606 and the best matching block. Next, at step 308, the method encodes motion information, such as a differential motion vector, for current macroblock 606. As explained above, the differential motion vector represents a difference between the motion vector of current macroblock 606 and its predictor motion vector. According to an exemplary embodiment of motion vector array 210 shown in FIG. 8, the predictor motion vector of current macroblock 606 is preferably the median of neighboring motion vectors MV2, MV3 and MV5. After encoding texture and motion information for current macroblock 606, at step 310 the method updates motion vector array 210 with the best matching motion vector, illustrated as MV6 in FIG. 8, for current macroblock 606.

With step 310, the method has completed motion estimation and compensation for current macroblock 606. Next, the method continues by repeating steps 302 to 310 for each macroblock in current frame 608 that is to be encoded. An exemplary processing order for macroblocks in current frame 608 in shown in FIG. 10. Further, to encode a stream of video data, the above method is repeated for each frame in the stream.

According to various embodiments, the present invention advantageously incorporates the cost of motion information while searching for a best matching motion vector without performing the large number of calculations associated with a full search of search area 602. One embodiment of a method for multiresolution motion estimation and compensation has been described in detail in U.S. patent application Ser. No. 09/924,079, which is incorporated by reference herein in its entirety. One skilled in the art will recognize that the present invention can be applied to that embodiment of multiresolution motion estimation and compensation by incorporating the cost of motion information while searching for the best matching block for current macroblock 606.

Referring now to FIG. 4, a second embodiment of a method for multiresolution motion estimation and compensation will be described. The method is explained with reference to motion estimation and compensation for an exemplary current macroblock 606 in current frame 608 being encoded in reference to reference frame 604.

The method starts at step 450 by performing a partial pixel level search of search area 602 to find the preliminary matching block 706 for current macroblock 606 as illustrated in FIG. 7A. According to an exemplary embodiment, preliminary matching block 706 is associated with preliminary motion vector 704, which describes the spatial offset between coordinates of the center 702 of search area 602 and the coordinates of the top left pixel of preliminary matching block 706.

The partial pixel level search of step 450 is now described in more detail with reference to current macroblock 606 of size 16×16 pixels that is selected for compression. A partial pixel level search is a low resolution search of search area 602. Search area 602 is sub-sampled to select one or more blocks for comparison to current macroblock 606. According to an exemplary embodiment, blocks selected for comparison are separated from each other by 4 pixels in the vertical or horizontal direction. Since each selected block is of size 16×16 pixels in the present example, one skilled in the art will recognize that neighboring blocks will overlap partially with each other. By sub-sampling search area 602, a partial pixel level search advantageously requires less comparisons over search area 602 than an exhaustive search. Once search area 602 has been sub-sampled, the method determines the total cost of encoding current macroblock 606 in reference to each block selected for comparison in the low resolution search. Preferably, the total cost incorporates a cost of motion information as well as a cost of texture information as shown in equation 6 above. The selected block that results in the lowest total cost for encoding current macroblock 606 is preferably selected as preliminary matching block 706. To complete step 450, the method stores the preliminary motion vector 704 for current macroblock 606 in preliminary motion vector array 254. Referring to FIG. 9, preliminary motion vector 704 is represented as MVp6 in preliminary motion vector array 254.

The method of multiresolution motion estimation and compensation continues at step 452 by performing a full pixel level search to find the intermediate matching block (not shown) and its associated intermediate motion vector 724 for current macroblock 606 as illustrated in FIG. 7B. According to an exemplary embodiment, intermediate motion vector 724 describes the spatial offset between the coordinates of center 702 of search area 602 and the coordinates of the top left pixel of the intermediate matching block.

The full pixel level search of step 452 is now described in more detail. A full pixel level search starts with preliminary motion vector 704 and performs a search at pixel level resolution to obtain a refined estimate of the best matching motion vector for current macroblock 606. The refined estimate is represented by intermediate motion vector 724. An advantage of multiresolution motion estimation and compensation is that the full pixel level search only needs to be performed on a limited portion of search area 602 that is defined by preliminary motion vector 704. As described above, an exemplary embodiment of a partial pixel level search selects blocks for comparison that are separated by 4 pixels in the vertical or horizontal direction. According to this embodiment, to select the best pixel level matching block as the intermediate matching block, the full pixel level search may be limited to blocks within 2 pixels vertically or horizontally of preliminary matching block 706. Therefore, the motion vectors for blocks selected for the full pixel level search may be limited to full pixel search area 740 as illustrated in FIG. 7B.

The full pixel level search is an exhaustive search of each block whose top left pixel falls within full pixel search area 740. Once full pixel level search area 740 has been determined, the method determines the total cost of encoding current macroblock 606 in reference to each block whose top left pixel falls within full pixel search area 740. Preferably, the total cost incorporates a cost of motion information as well as a cost of texture information as shown in equation 6 above. The block that results in the lowest total cost for encoding current macroblock 606 is preferably selected as the intermediate matching block. To complete step 452, the method stores the intermediate motion vector 724 for current macroblock 606 in intermediate motion vector array 264. Referring to FIG. 9, intermediate motion vector 724 is represented as Mvi6 in intermediate motion vector array 264.

The method of multiresolution motion estimation and compensation continues at step 454 by performing a fractional pixel level search to find the final matching block (not shown), which is also referred to as the best matching block, and its associated final motion vector 734 for current macroblock 606 as illustrated in FIG. 7C. According to an exemplary embodiment, final motion vector 734 describes the spatial offset between the coordinates of center 702 of search area 602 and the coordinates of the top left pixel of the final matching block.

The fractional pixel level search of step 454 is now described in more detail. Step 454 starts by computing the fractional pixels surrounding each pixel in the intermediate matching block. According to an exemplary embodiment, a fractional pixel represents the average of its surrounding pixels. For example, referring to FIG. 7C, fractional pixel h1 762 is the average of the four pixels surrounding it, which are represented by circles. To provide another example, fractional pixel h2 764 is the average of the pixels above and below it. While FIG. 7C shows half pixels, various other types of fractional pixels may be used, for example one-third pixels or quarter pixels. The fractional pixel level search at step 454 receives intermediate motion vector 724 as input and performs a search at fractional pixel resolution to obtain the best matching motion vector for current macroblock 606. The best matching motion vector is represented by final motion vector 734.

An advantage of multiresolution motion estimation and compensation is that the fractional pixel level search only needs to be performed on a limited portion of search area 602 that is defined by intermediate motion vector 724. According to one embodiment, to ensure that the best fractional pixel matching block is selected as final matching block 734, the fractional pixel level search may be limited to blocks whose top left pixels, which may be fractional pixels, fall within one fractional pixel of intermediate motion vector 724. Therefore, as illustrated in FIG. 7C, the fractional pixel level search may be limited to blocks whose top left pixels fall within fractional pixel search area 750. One skilled in the art will understand that the blocks whose top left pixels fall within fractional pixel search area 750 are 16×16 blocks including fractional pixels as well as full pixels. Next, the method determines the total cost of encoding current macroblock 606 in reference to each block the fractional pixel search area 750. Preferably, the total cost incorporates a cost of motion information as well as a cost of texture information, as shown in equation 6 above. The block that results in the lowest total cost for encoding current macroblock 606 is preferably selected as the best matching block (not shown). To complete step 454, the method stores the final motion vector 734 for current macroblock 606 in final motion vector array 274. Referring to FIG. 9, final motion vector 734 is represented as MVf6 in final motion vector array 274.

Referring again to FIG. 4, at the end of step 454, the method has determined the best matching block and the best matching motion vector (i.e. final motion vector 734) for current macroblock 606. The method continues at step 456 by encoding texture information for current macroblock 606, such as residual data representing the differences between corresponding pixels of current macroblock 606 and the best matching block. Next, at step 458, the method encodes motion information for current macroblock 606. As explained above, according to one embodiment, motion information is encoded as a differential motion vector representing a difference between the final motion vector 734 of current macroblock 606 and its predictor motion vector. According to an exemplary embodiment of final motion vector array 274 shown in FIG. 9, the predictor motion vector of current macroblock 606 is preferably the median of neighboring motion vectors MVf2, MVf3 and MVf5.

With step 458, the method has completed multiresolution motion estimation and compensation for current macroblock 606. Next, the method continues by repeating steps 450 to 458 for each macroblock in current frame 608 that is to be encoded. An exemplary processing order for macroblocks in current frame 608 in shown in FIG. 10. Further, to encode a stream of video data, the above method is repeated for each frame in the stream.

The above description is included to illustrate the operation of exemplary embodiments and is not meant to limit the scope of the invention. The scope of the invention is to be limited by only the following claims. From the above discussion, many variations will be apparent to one skilled in the relevant art that would yet be encompassed by the spirit and scope of the invention.

1. A method for compressing video data, the method comprising the steps of:
receiving a block for compression;
determining a motion vector that lowers a cost of encoding the block; and
encoding the block with reference to the motion vector.

2. The method of claim 1, wherein the step of receiving the block for compression includes the steps of:
receiving one or more blocks; and
selecting the block for compression.

3. The method of claim 1, wherein the step of determining the motion vector includes the steps of:
searching a reference frame for one or more motion vectors that lower one or more costs of encoding the block including one or more costs of encoding motion information;
determining the motion vector providing a lowest cost of encoding the block including a cost of encoding the motion information.

4. The method of claim 3, wherein the block is part of a new frame and wherein the reference frame is a previous frame.

5. The method of claim 1, wherein encoding the block comprises encoding motion information, and wherein the motion information comprises one of the motion vector and a differential motion vector.

6. The method of claim 5, wherein the differential motion vector represents a difference between the motion vector and a predictor motion vector.

7. The method of claim 6, wherein the predictor motion vector represents a median motion vector of a block in a frame comprising the block.

8. The method of claim 1, wherein the step of determining the motion vector that lowers the cost of encoding the block includes determining the motion vector that lowers a cost of encoding motion information.

9. The method of claim 1, wherein the step of determining the motion vector that lowers the cost of encoding the block includes determining the motion vector that lowers a cost of encoding texture information.

10. The method of claim 9, wherein the texture information represents residual data for the block, and wherein the cost of encoding the texture information includes a sum of absolute differences between corresponding pixels of the block and a matching block corresponding to the motion vector.

11. The method of claim 9, wherein a value is used to scale the cost the encoding the texture information.

12. The method of claim 11, wherein the value represents a quantization scale.

13. The method of claim 8, wherein a value is used to scale the cost the encoding the motion information.

14. The method of claim 13, wherein the value represents a quantization scale.

15. A method of compressing video data, the method comprising the steps of:
receiving a block for compression;
searching a reference frame to find a matching block that lowers a cost of encoding motion information for the block; and
searching a portion of the reference frame near the matching block to find a refined matching block that further lowers the cost of encoding the motion information for the block.

16. The method of claim 15, further comprising encoding the block in reference to the refined matching block.

17. The method of claim 15, wherein at least one of the steps of searching the reference frame and searching the portion of the reference frame comprises at least one of a partial pixel level search, a full pixel level search, and a fractional pixel level search.

18. The method of claim 15, further comprising:
searching a portion of the reference frame near the refined matching block to find an enhanced matching block that further lowers the cost of encoding the motion information for the block; and
encoding the block in reference to the enhanced matching block.

19. The method of claim 15, wherein the step of receiving the block for compression includes the steps of:
receiving one or more blocks; and
selecting the block for compression.

20. The method of claim 15, wherein the block is part of a frame and wherein the reference frame is a previous frame.

21. The method of claim 16, wherein encoding the block comprises encoding the motion information for the block, and wherein the motion information comprises one of a motion vector and a differential motion vector.

22. The method of claim 21, wherein the differential motion vector for the block represents a difference between the motion vector and a predictor motion vector.

23. The method of claim 22, wherein the predictor motion vector represents a median motion vector of a block in a frame comprising the block.

24. The method of claim 15, wherein the step of searching the reference frame comprises searching the reference frame to find the matching block that lowers a cost of encoding texture information for the block in addition to the cost of encoding the motion information for the block.

25. The method of claim 24, wherein the step of searching the portion of the reference frame near the matching block comprises searching the portion of the reference frame near the matching block to find the refined matching block that further lowers the cost of encoding the texture information for the block in addition to the cost of encoding the motion information for the block.

26. The method of claim 25, wherein the texture information represents residual data for the block, and wherein the cost of encoding the texture information comprises a sum of absolute differences between corresponding pixels of the block and the matching block.

27. A system for compressing a block of video data, the system comprising:
a search module having a first input, a second input, and an output for searching one or more blocks in a reference frame for a matching block that lowers a cost of encoding motion information for the block, the first input of the search module coupled to receive the block, the second input of the search module coupled to receive the reference frame; and
a cost calculator having an input and an output for determining the cost of encoding the motion information for the block in reference to a block in the reference frame, the input of the cost calculator coupled to the output of the search module.

28. The system of claim 27, further comprising a block selector having an input and an output for selecting the block, the input of the block selector coupled to receive one or more blocks, the output of the block selector coupled to provide the selected block to the first input of the search module.

29. The system of claim 27, further comprising a memory coupled to the second input of the search module for providing the reference frame.

30. The system of claim 27, further comprising:
a memory having an input and an output for storing a motion vector corresponding to the matching block, the input of the memory coupled to the output of the search module to receive the motion vector; and
a motion information encoder coupled to the output of the memory for encoding the motion information for the block.

31. The system of claim 30, wherein the motion information for the block comprises a differential motion vector that represents a difference between the motion vector and a predictor motion vector.

32. The system of claim 27, wherein the search module searches the one or more blocks in the reference frame for the matching block that lowers a cost of encoding texture information for the block, and wherein the system further comprises a texture information encoder coupled to the output of the search module for encoding texture information for the block.

33. The system of claim 32, wherein the texture information for the block comprises residual data that represents a sum of absolute differences between corresponding pixels of the block and the matching block.

34. A system for compressing a block of video data, the system comprising:
a first search module having a first input, a second input, and an output for searching one or more blocks in a reference frame for a matching block that lowers a cost of encoding motion information for the block, the first input of the first search module coupled to receive the block, the second input of the first search module coupled to receive the reference frame; and
a second search module having a first input, a second input, and an output for searching a portion of the reference frame near the matching block for a refined matching block that further lowers the cost of encoding the motion information for the block, the first input of the second search module coupled to receive the block and the matching block from the output of the first search module, the second input of the second search module coupled to receive the reference frame.

35. The system of claim 34, further comprising:
a cost calculator having an input and an output for determining the cost of encoding the motion information for the block in reference to one of the blocks in the reference frame, the input of the cost calculator coupled to receive the block and the one of the blocks in the reference frame from the output of at least one of the first search module and the second search module.

36. The system of claim 34, further comprising:
a third search module having a first input, a second input, and an output for searching a portion of the reference frame near the refined matching block for an enhanced matching block that further lowers the cost of encoding the motion information for the block, the first input of the third search module coupled to receive the block and the refined matching block from the output of the second search module, the second input of the third search module coupled to receive the reference frame.

37. The system of claim 34, further comprising:
a memory having an input and an output for storing a motion vector corresponding to the refined matching block, the input of the memory coupled to the output of the second search module to receive the motion vector; and
a motion information encoder coupled to the output of the memory for encoding the motion information for the block.

38. The system of claim 37, wherein the motion information for the block comprises a differential motion vector that represents a difference between the motion vector and a predictor motion vector.

39. The system of claim 34, wherein at least one of the first search module and the second search module searches to lower a cost of encoding texture information for the block in addition to the cost of encoding motion information for the block, further comprising a texture information encoder coupled to the output of the second search module for encoding the texture information for the block.

40. The system of claim 39, wherein the texture information for the block comprises residual data that represents a sum of absolute differences between corresponding pixels of the block and one of the blocks from the reference frame.
